(19) United States
(12) Patent Application Publication
(10) Pub. No.: US 2022/0163919 A1
(43) Pub. Date: May 26, 2022

(54) MICROMIRROR PIXEL DESIGN TO ELIMINATE INTENSITY ARTIFACTS IN HOLOGRAPHIC DISPLAYS

(71) Applicant: GM GLOBAL TECHNOLOGY OPERATIONS LLC, Detroit, MI (US)

(72) Inventors: Thomas A. SEDER, Fraser, MI (US); Kai-Han CHANG, Madison Heights, MI (US)

(21) Appl. No.: 17/101,013

(22) Filed: Nov. 23, 2020

(51) Int. Cl. G03H 1/22; G03H 1/00; G02B 27/01; B60K 35/00

(52) U.S. Cl. CPC G03H 1/2294; G03H 1/0005; G02B 27/0103; B60K 35/00; B60K 2370/166; G03H 2225/52; G03H 2226/02; B60K 2370/1529; B60K 2370/178; G03H 2001/0088

(57) ABSTRACT

A spatial light modulator includes a semiconductor substrate and a plurality of micro-mirrors arranged on the semiconductor substrate to modulate light. Each of the micro-mirrors has a center and a perimeter. Each of the micro-mirrors includes a layer of a reflective material arranged on the semiconductor substrate. In in each of the micro-mirrors, the layer of the reflective material extends horizontally from the center towards the perimeter for a predetermined distance and slopes downwards towards the semiconductor substrate after the predetermined distance.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to display systems and more particularly to micro-mirror pixel design to eliminate intensity artifacts in holographic displays.

Head-up Displays (HUDs) can be used in vehicles to assist occupants in vehicle navigation. For example, the HUDs can be used to project data from the dashboard and other vehicle related data in a virtual image (e.g., a hologram) in front of the windshield. In addition, in the virtual image, the HUDs can annotate objects (e.g., vehicles, cyclists, pedestrians, landmarks, etc.) with virtual signs, display navigational data (e.g., turn arrows, highlighted exits, etc.), enhance vision at night and in low visibility conditions (e.g., fog, rain, blizzard, etc.), and so on. The HUDs can improve situation awareness of the occupants and improve occupants' comfort level and trust in autonomous driving capabilities of vehicles.

### SUMMARY

A spatial light modulator comprises a semiconductor substrate and a plurality of micro-mirrors arranged on the semiconductor substrate to modulate light. Each of the micro-mirrors has a center and a perimeter. Each of the micro-mirrors includes a layer of a reflective material arranged on the semiconductor substrate. In in each of the micro-mirrors, the layer of the reflective material extends horizontally from the center towards the perimeter for a predetermined distance and slopes downwards towards the semiconductor substrate after the predetermined distance.

In another feature, the layer of the reflective material slopes downwards towards the semiconductor substrate at an acute angle relative to a plane of the semiconductor substrate.

In another feature, the spatial light modulator further comprises an annular layer of the reflective material arranged on the semiconductor substrate, and the annular layer surrounds the layer.

In another feature, the layer is wider than the annular layer.

In another feature, the layer is thicker than the annular layer.

In another feature, the layer is wider and thicker than the annular layer.

In other features, the spatial light modulator further comprises an annular layer of the reflective material arranged on the semiconductor substrate. The annular layer surrounds the layer and is narrower and thinner than the layer. Inner and outer edges of the annular layer slope downwards towards the semiconductor substrate at the acute angle relative to the plane of the semiconductor substrate.

In other features, the spatial light modulator further comprises first and second annular layers of the reflective material arranged on the semiconductor substrate. The first annular layer surrounds the layer, and the second annular layer surrounds the first annular layer.

In other features, an outer edge of the layer and inner and outer edges of the first and second annular layers slope vertically downwards towards the semiconductor substrate.

In other features, the layer and the first and second annular layers have the same thickness.

In other features, the layer is wider than the first and second annular layers, and the first and second annular layers have the same width.

In other features, a distance between an outer edge of the layer and an inner edge of the first annular layer is the same as a distance between an outer edge of the first annular layer and an inner edge of the second annular layer.

In other features, an outer edge of the layer and inner and outer edges of the first and second annular layers slope vertically downwards towards the semiconductor substrate. The layer and the first and second annular layers have the same thickness. The layer is wider than the first and second annular layers. The first and second annular layers have the same width. A distance between an outer edge of the layer and an inner edge of the first annular layer is the same as a distance between an outer edge of the first annular layer and an inner edge of the second annular layer.

In another feature, each of the micro-mirrors is square-shaped.

In other features, a head-up display system for a vehicle comprises the spatial light modulator, one or more sensors to sense data associated with the vehicle, a processor to process the sensed data and output the processed data to the spatial light modulator as a hologram, and a light source to output light to the spatial light modulator. The spatial light modulator diffracts the light from the hologram on the spatial light modulator and displays the hologram through a windshield of the vehicle.

In another feature, the sensed data includes data from a dashboard of the vehicle.

In another feature, the sensed data includes data regarding objects around the vehicle.

In other features, the processor outputs additional data with the processed data to the spatial light modulator, and the additional data is superimposed on the sensed data displayed in the hologram.

In other features, the additional data includes at least one of an annotation, a warning, and navigational data.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an example of a Head-up Display (HUD) system for a vehicle according to the present disclosure;

FIG. 2 shows an example of an image projected using the HUD system of FIG. 1;

FIG. 3 shows a diffraction pattern from a single pixel (micro-mirror) of a Spatial Light Modulator (SLM) used in the HUD system of FIG. 1;

FIGS. 4 and 5 show an example of a method of manufacturing the SLM with pixelated micro-mirrors having a designed reflectance profile to produce a desired far-field light distribution;

FIGS. 6 and 7 show another example of a method of manufacturing the SLM with pixelated micro-mirrors having a designed reflectance profile to produce a desired far-field light distribution; and

FIGS. 8 and 9 show yet another example of a method of manufacturing the SLM with pixelated micro-mirrors having a designed reflectance profile to produce a desired far-field light distribution.

In the drawings, reference numbers may be reused to identify similar and/or identical elements.

### DETAILED DESCRIPTION

Augmented Reality (AR) based Head-up Displays (HUDs) can be used to produce virtual images that fuse with and can be overlaid on real world objects to enhance situation awareness by increasing saliency of relevant objects, annotating real world objects with useful information, and improving user experience. Images can be projected on the HUDs using Computer Generated Holography (CGH). In CGH, a hologram of an object is calculated and encoded onto a Spatial Light Modulator (SLM), which includes pixelated micro-mirrors and associated memory elements arranged in an array. A desired wave-front is reproduced when the SLM is irradiated with a reference wave. The micro-mirrors modulate the light according to the data stored in the associated memory elements. A superimposed output of all of the pixels (i.e., micro-mirrors) produces the desired wave-front, which projects the hologram on the HUD. To precisely reconstruct the object's wave-front, the SLM modulates both amplitude and phase of the reference wave using the micro-mirrors.

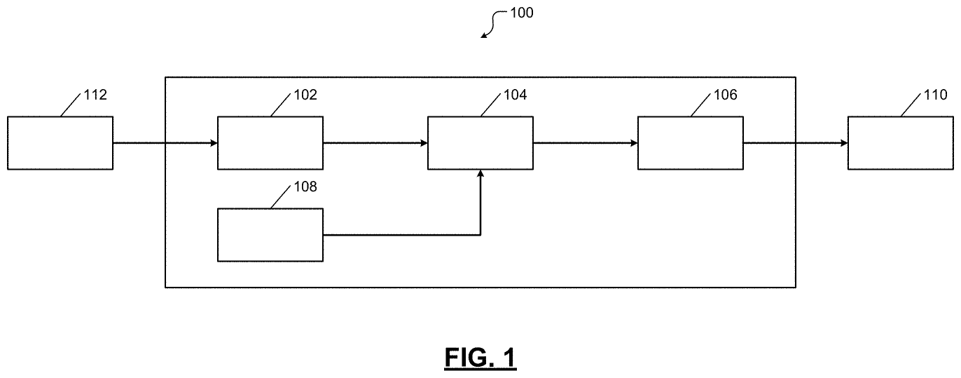

FIG. 1 shows an example of a Head-up Display (HUD) system 100 for a vehicle. The system 100 comprises a processor 102, a Spatial Light Modulator (SLM) 104, a lens 106, and a light source 108. The system 100 further comprises a screen 110 (e.g., the windshield of the vehicle). The system 100 further comprises various sensors 112 of the vehicle. For example, the sensors 112 may include cameras, radar, Lidar, and other sensors that sense objects around the vehicle. Additionally, the sensors 112 may include other sensors that sense various parameters of the vehicle such as speed, tire pressure, cabin temperature, statuses of restraints such as seat belts, and so on, which are typically displayed on the dashboard of the vehicle.

The processor 102 processes the data captured by the sensors 112 and calculates a hologram of object(s) that is to be projected in front of the screen 110. The processor 102 can add information to the hologram such as data from the dashboard of the vehicle, map of the road being traveled by the vehicle, and other annotations such as warnings (e.g., to highlight a pedestrian, a cyclist, etc.). For example, the processor 102 can retrieve navigational data such as maps, weather, traffic, etc. from the Internet (e.g., from a server in cloud via cellular or satellite communication link from the vehicle). The processor 102 can retrieve information about a nearby landmark (e.g., a museum, a restaurant, parking, etc.). The processor 102 can add these types of data to the hologram.

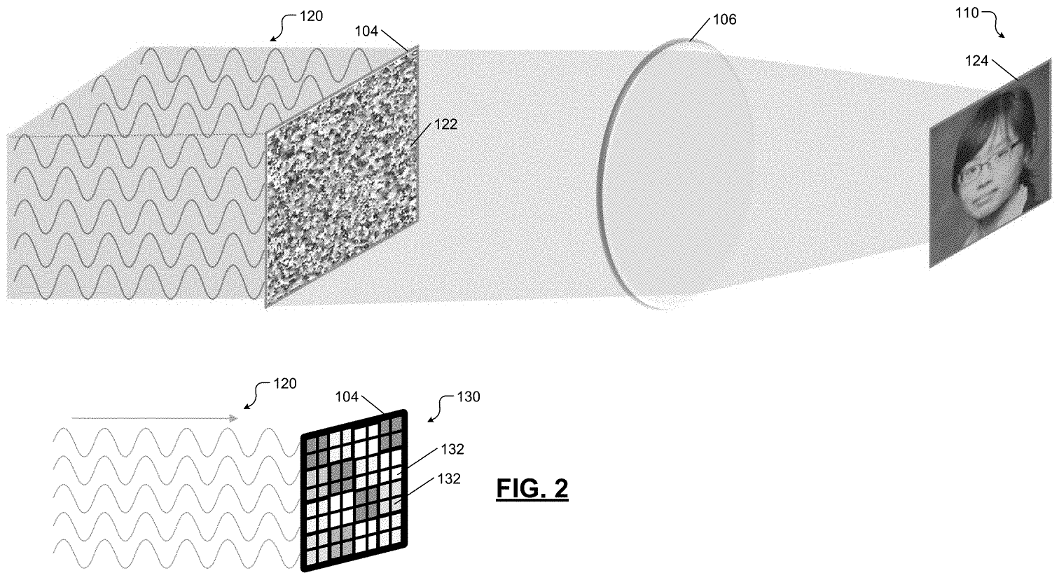

The processor 102 encodes the image data (and the additional data to be displayed in the hologram) onto the SLM 104. The light source 108 irradiates the micro-mirrors (shown in FIG. 2) in the SLM 104, which modulate the light. The modulated light output by the SLM 104 passes through the lens 106, and the holographic image is projected in front of the screen 110.

FIG. 2 shows an example of an image projected using the system 100 of FIG. 1. An example of coherent illumination from the light source 108 (e.g., RGB laser diodes) is shown at 120. An example of an image encoded onto the SLM 104 is shown at 122. An example of a hologram of an image projected in front of the screen 110 is shown at 124. An example of an array 130 of micro-mirrors 132 of the SLM 104 is also shown. The plane of the SLM 104 (i.e., the plane of the array 130 of micro-mirrors 132 of the SLM 104) is called a source plane, and the plane of the image 124 projected in front of the screen 110 is called an image plane.

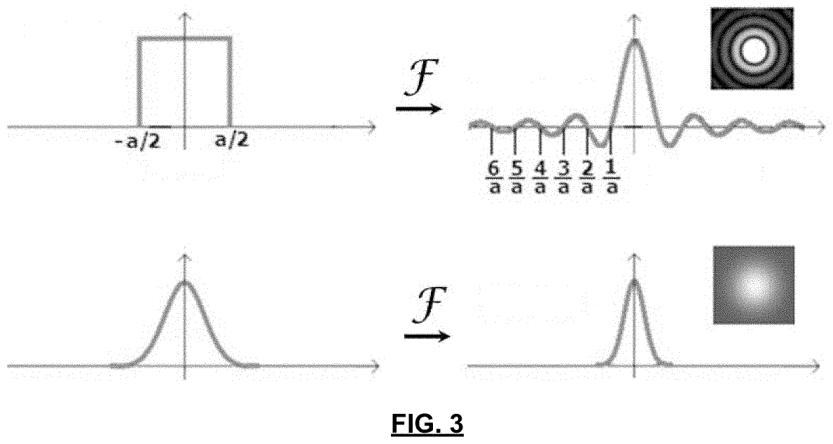

FIG. 3 shows a diffraction pattern from a single pixel (micro-mirror) of an SLM. In conventional SLMs with square pixels (micro-mirrors), the reflectance is constant throughout each square pixel. Accordingly, the diffraction pattern of each square pixel with constant reflectance is a sinc function 150 with side lobes 151-1, 151-2, 151-3, etc. (collectively the side lobes 151). The side lobes 151 introduce image artifacts 152-1, 152-2, 152-3, etc. (collectively the image artifacts 152) into the holographic image, which reduces the image quality.

The present disclosure provides various methods to implement a designed pixel reflectance profile for each micro-mirror 132 in the SLM 104 to eliminate the image artifacts 152 in the holographic image 124. The diffraction pattern from the designed reflectance profile of the micro-mirrors 132 in the SLM 104 is without the side lobes 151 and hence without the image artifacts 152, which improves the quality of the holographic image 124.

Specifically, a diffraction pattern of a pixel (micro-mirror) of the SLM is a Fourier transform of the reflectance distribution of the pixel. Accordingly, the side lobes 151 (and the image artifacts 152) can be eliminated if the reflectance distribution in the pixel is a Gaussian function or a Sinc function as shown at 160. Since the Fourier transform of a Gaussian is a Gaussian, pixels that generate a Gaussian reflectance produce artifact-free intensity distributions at the image plane, which improves the image quality.

The present disclosure provides various methods for creating the desired reflectance profile on the micro-mirror pixels of the SLM using contact/non-contact photolithography. The SLM with the pixelated micro-mirrors having the designed reflectance profile tailors the light distribution reflected from the micro-mirror array in the SLM, which eliminates the image artifacts 152 in holographic displays that arise due to the square form and uniform reflectance of micro-mirrors in conventional SLMs. In the SLM using micro-mirrors designed according to the present disclosure, the reflected light distribution is tailored to a Gaussian or Airy Disk (explained below) distribution by spatially altering the reflection profile of the mirror surface, which upon diffraction into far-field (Fraunhofer regime), produces a Gaussian or square wave intensity distribution, respectively.

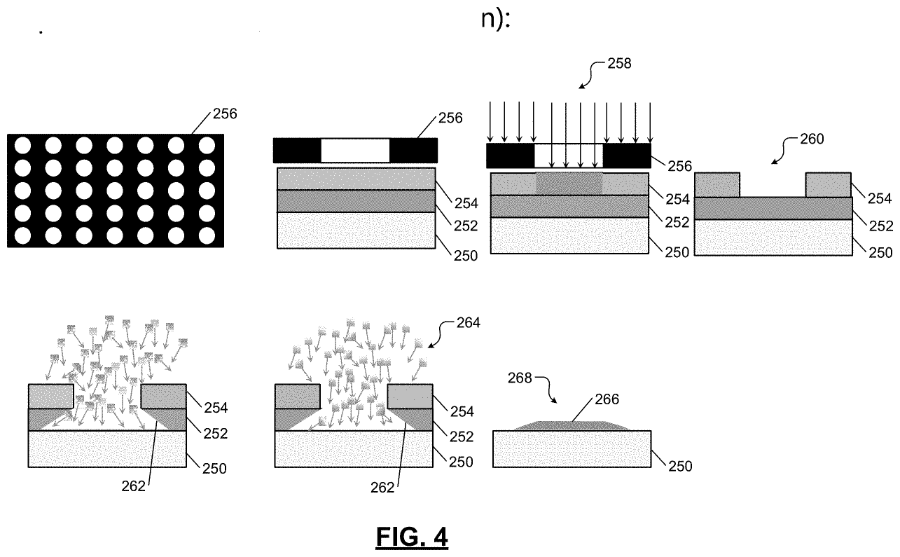

The present disclosure provides three methods for altering the reflectance profile of the micro-mirrors of the SLM to produce a desired far-field light distribution in holographic displays. These methods are shown and described below in detail with reference to FIGS. 4-9.

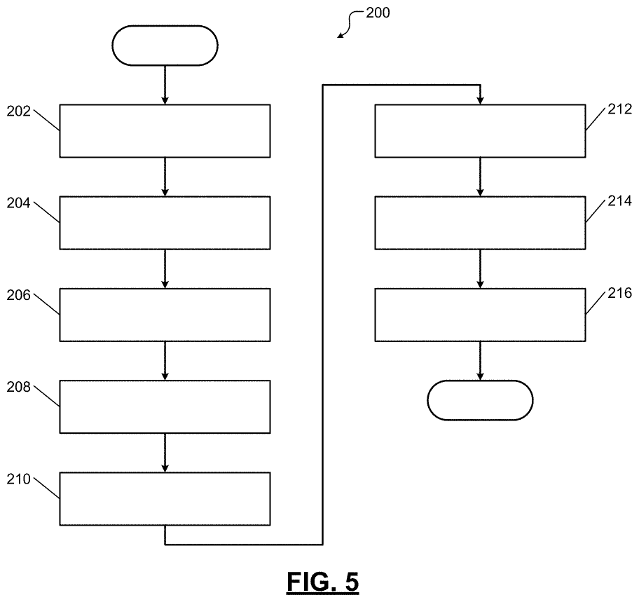

FIGS. 4 and 5 show a first method 200 for producing pixelated micro-mirrors for an SLM with a designed reflectance profile to produce a desired far-field light distribution in holographic displays. FIG. 5 shows a flowchart of the first method 200. FIG. 4 shows the structures and the steps of the first method 200 performed on the corresponding structures.

In the first method 200, at 202, on an array of micro-mirrors 250 arranged on a semiconductor substrate, a polymethylglutarimide (PMGI) layer 252 is deposited. At 204, a photoresist layer 254 is deposited on the PMGI layer 252. At 206, a mask 256 with holes (one hole per pixel) is overlaid on the photoresist layer 254.

At 208, the photoresist layer 254 is cured as shown at 258 in FIG. 4. At 210, the photoresist layer 254 is washed (shown at 260 in FIG. 4). At 212, a reactive etching of the PMGI layer 252 is performed under the photoresist layer 254 as shown at 262 in FIG. 5. The etching progresses radially outwardly from the top to bottom of the PMGI layer 253 at a predetermined slope as shown at 262 in FIG. 4.

At 214, a reflective material (e.g., aluminum) is deposited (e.g., using a deposition process such as chemical vapor deposition or CVD) in the etched region of the PMGI layer 252 as shown at 264 in FIG. 4. The deposited material has a circularly symmetric gradient thickness.

At 216, the mask 256 is removed, and the photoresist and PMGI layers 254, 252 are washed. The result is an array of micro-mirrors 250 on the semiconductor substrate with each micro-mirror having a layer of the reflective material 266 that radially (i.e., horizontally) extends from a center of the square micro-mirror towards the perimeter of the micro-mirror. The layer of the reflective material 266 has a predetermined, uniform thickness from the center to about a halfway point between the center and the perimeter of the square micro-mirror. From about the halfway point, the thickness of the layer of the reflective material 266 decreases (i.e., an outer edge of the reflective material 266 tapers) linearly at a slope of about 45 degrees (or between about 30 and 60 degrees) towards the perimeter of the square micro-mirror.

Accordingly, in a side cross-sectional view of the square micro-mirror seen in FIG. 4 at 268, the layer of the reflective material 266 has a trapezoidal shape. The reflectance of the reflective material 266 is positively correlated with the thickness of the material for thin films. When the micro-mirrors with the layer of the reflective material 266 modulate light, the tapering thickness of the layer of the reflective material 266 eliminates the side lobes 151 and the image artifacts 152 from the holographic image 124.

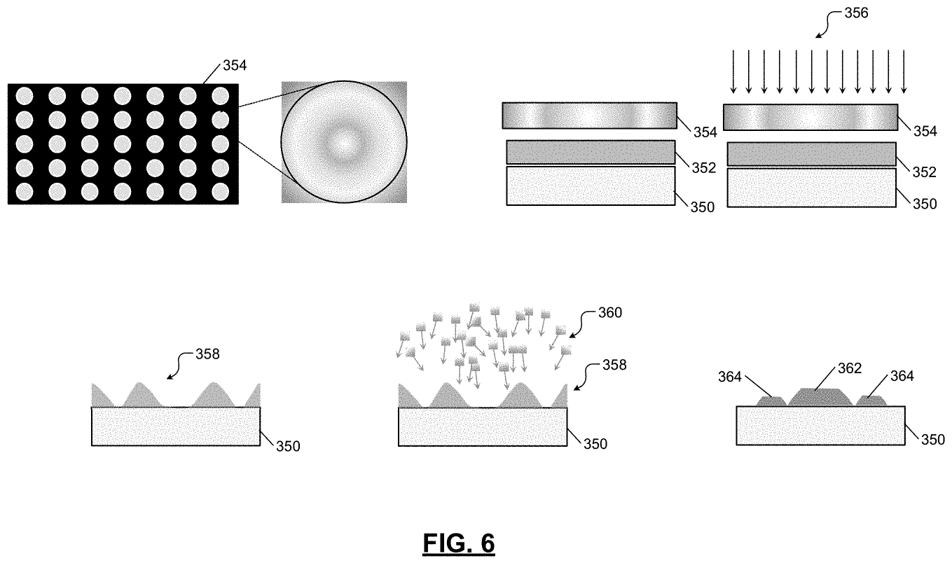

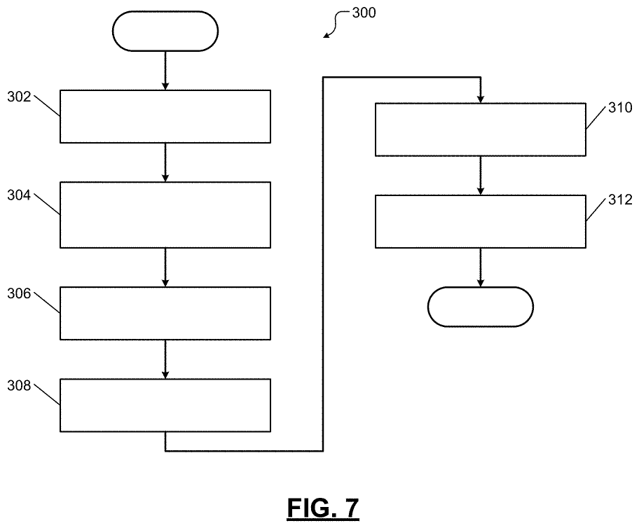

FIGS. 6 and 7 show a second method 300 for producing pixelated micro-mirrors for an SLM with a designed reflectance profile to produce a desired far-field light distribution in holographic displays. FIG. 7 shows a flowchart of the second method 300. FIG. 6 shows the structures and the steps of the second method 300 performed on the corresponding structures.

In the second method 300, at 302, on an array of micro-mirrors 350 arranged on a semiconductor substrate, a photoresist layer 352 is deposited. At 304, an airy disk mask 354 with one airy disk per pixel is arranged above the photoresist layer 352. At 306, the photoresist layer 352 is cured as shown at 356 in FIG. 6.

At 308, the photoresist layer 352 is washed (shown at 358 in FIG. 6). An airy disk pattern is created on the micro-mirror as seen at 358 in FIG. 6. At 310, a reflective material (e.g., aluminum) is deposited (e.g., using a deposition process such as chemical vapor deposition or CVD) on the airy disk pattern created on the micro-mirror (shown at 360 in FIG. 6). At 312, the airy disk mask 354 is removed.

The result is an array of micro-mirrors 350 on the semiconductor substrate with each micro-mirror having a layer of the reflective material including a center portion 362 at a center of the square micro-mirror and an annular portion 364 around the center portion 362, which creates an airy disk reflectance profile on the micro-mirror pixel. The center portion 362 has a first predetermined, uniform thickness (or height) from the center of the square micro-mirror to a first point between the center of the square micro-mirror and the perimeter of the square micro-mirror.

From the first point, the first thickness (or height) of the center portion 362 decreases (i.e., an outer edge of the center portion 362 tapers) linearly at a slope of about 45 degrees (or between 30-60 degrees) towards the annular portion 364 to a second point between the center of the square micro-mirror and the perimeter of the square micro-mirror. For example, the second point may be halfway between the center of the square micro-mirror and the perimeter of the square micro-mirror. Accordingly, the center portion 362 has a first width (i.e., area having the first height from the center of the square micro-mirror to the first point at which tapering begins).

The annular portion 364 has a second predetermined, uniform thickness (or height) that is less than the first height of the center portion 362. The annular portion 364 has a second width that is less than the first width of the center portion 362. The second thickness (or height) of the annular portion 364 also decreases at a slope of about 45 degrees (or between 30-60 degrees) towards the perimeter and towards the center of the square micro-mirror (i.e., both inner and outer edges of the annular portion 364 taper). An inner bottom edge of the tapered portion of the annular portion 364 may contact an outer bottom edge of the center portion 362.

Accordingly, in a side cross-sectional view of the square micro-mirror seen in FIG. 6, each of the center portion 362 and the annular portion 364 has a trapezoidal shape. When the micro-mirrors with the center portion 362 and the annular portion 364 modulate light, the tapering thicknesses of the center portion 362 and the annular portion 364 eliminate the side lobes 151 and the image artifacts 152 from the holographic image 124.

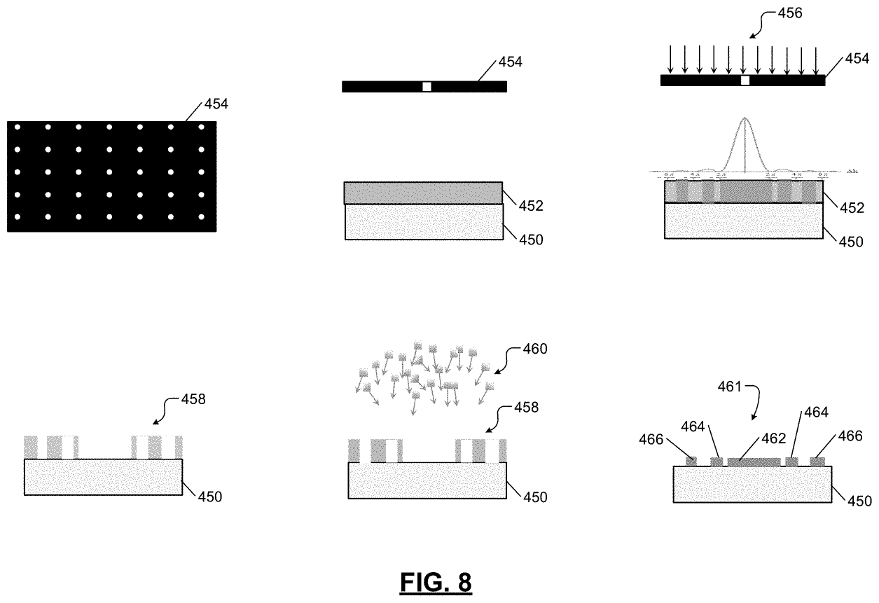

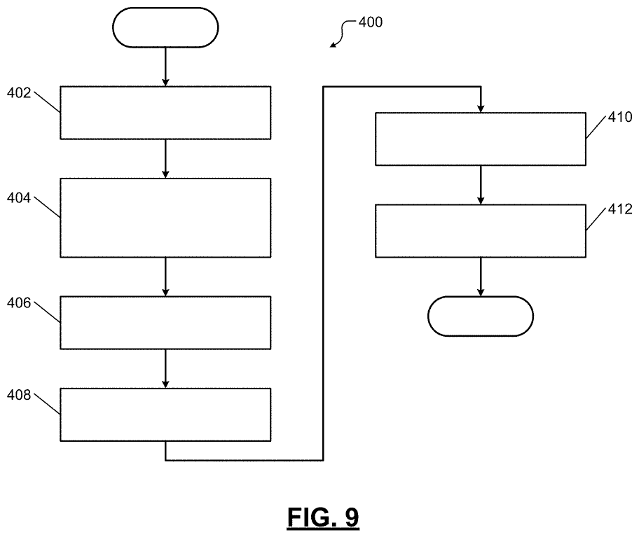

FIGS. 8 and 9 show a third method 400 for producing pixelated micro-mirrors for an SLM with a designed reflectance profile to produce a desired far-field light distribution in holographic displays. FIG. 9 shows a flowchart of the second method 400. FIG. 8 shows the structures and the steps of the second method 400 performed on the corresponding structures.

In the third method 400, at 402, on an array of micro-mirrors 450 arranged on a semiconductor substrate, a photoresist layer 452 is deposited. At 404, a pin hole mask or a lens array 454 with one pin hole or lens per pixel is arranged above the photoresist layer 452. At 406, the photoresist layer 452 is cured using intensity distribution of a sinc function resulting from diffraction through the pin hole mask 454 as shown at 456 in FIG. 8.

At 408, the photoresist layer 452 is washed (shown at 458 in FIG. 8). A pattern similar to the sinc function is created on the micro-mirror as seen at 458 in FIG. 8. At 410, a reflective material (e.g., aluminum) is deposited (e.g., using a deposition process such as chemical vapor deposition or CVD) on the sinc function pattern created on the micro-mirror (shown at 460 in FIG. 8). At 412, the pin hole mask 454 is removed. The result is an array of micro-mirrors 350 on the semiconductor substrate with each micro-mirror having a layer of the reflective material that has reflectance profile of the sinc function (airy disk) as seen at 461 in FIG. 8.

Specifically, each micro-mirror has a layer of the reflective material including at least three portions: a center portion 462, first annular portion 464, and a second annular portion 466. The center portion 462 is circular and extends radially from a center of the square micro-mirror to a first point between the center of the square micro-mirror and the perimeter of the square micro-mirror. The first point may be less than halfway between the center of the square micro-mirror and the perimeter of the square micro-mirror. The first annular portion 464 surrounds the center portion 462, and the second annular portion 466 surrounds the first annular portion 464.

An outer edge of the center portion 462 and inner and outer edges of the first and second annular portions 464, 466 are vertical (i.e., do not slope or taper). A radial distance between an outer edge of the center portion 462 and an inner edge of the first annular portion 464 is the same as a radial distance between an outer edge of the first annular portion 464 and an inner edge of the second annular portion 466. The thickness or height of the three portions is the same. The center portion 462 has a greater width than each of the first and second annular portions 464, 466. The first and second annular portions 464, 466 have the same width.

Accordingly, in a side cross-sectional view of the square micro-mirror seen in FIG. 8, each of the center portion 462 and the first and second annular portions 464, 466 has a rectangular shape, and the center portion 462 and the first and second annular portions 464, 466 form a sinc function pattern. When the micro-mirrors with the center portion 462 and the first and second annular portions 464, 466 modulate light, the sinc function pattern of the center portion 462 and the first and second annular portions 464, 466 eliminate the side lobes 151 and the image artifacts 152 from the holographic image 124.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules.

References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A spatial light modulator comprising:
a semiconductor substrate; and
a plurality of micro-mirrors arranged on the semiconductor substrate to modulate light,
wherein each of the micro-mirrors has a center and a perimeter;
wherein each of the micro-mirrors includes a layer of a reflective material arranged on the semiconductor substrate; and
wherein in each of the micro-mirrors, the layer of the reflective material:
extends horizontally from the center towards the perimeter for a predetermined distance; and
slopes downwards towards the semiconductor substrate after the predetermined distance.

2. The spatial light modulator of claim 1 wherein the layer of the reflective material slopes downwards towards the semiconductor substrate at an acute angle relative to a plane of the semiconductor substrate.

3. The spatial light modulator of claim 1 further comprising an annular layer of the reflective material arranged on the semiconductor substrate wherein the annular layer surrounds the layer.

4. The spatial light modulator of claim 3 wherein the layer is wider than the annular layer.

5. The spatial light modulator of claim 3 wherein the layer is thicker than the annular layer.

6. The spatial light modulator of claim 3 wherein the layer is wider and thicker than the annular layer.

7. The spatial light modulator of claim 2 further comprising:
an annular layer of the reflective material arranged on the semiconductor substrate;
wherein the annular layer surrounds the layer and is narrower and thinner than the layer; and
wherein inner and outer edges of the annular layer slope downwards towards the semiconductor substrate at the acute angle relative to the plane of the semiconductor substrate.

8. The spatial light modulator of claim 1 further comprising first and second annular layers of the reflective material arranged on the semiconductor substrate wherein the first annular layer surrounds the layer and wherein the second annular layer surrounds the first annular layer.

9. The spatial light modulator of claim 8 wherein an outer edge of the layer and inner and outer edges of the first and second annular layers slope vertically downwards towards the semiconductor substrate.

10. The spatial light modulator of claim 8 wherein the layer and the first and second annular layers have the same thickness.

11. The spatial light modulator of claim 8 wherein:
the layer is wider than the first and second annular layers; and
the first and second annular layers have the same width.

12. The spatial light modulator of claim 8 wherein a distance between an outer edge of the layer and an inner edge of the first annular layer is the same as a distance between an outer edge of the first annular layer and an inner edge of the second annular layer.

13. The spatial light modulator of claim 8 wherein:
an outer edge of the layer and inner and outer edges of the first and second annular layers slope vertically downwards towards the semiconductor substrate;
the layer and the first and second annular layers have the same thickness;
the layer is wider than the first and second annular layers;
the first and second annular layers have the same width; and
a distance between an outer edge of the layer and an inner edge of the first annular layer is the same as a distance between an outer edge of the first annular layer and an inner edge of the second annular layer.

14. The spatial light modulator of claim 1 wherein each of the micro-mirrors is square-shaped.

15. A head-up display system for a vehicle comprising:
the spatial light modulator of claim 1;
one or more sensors to sense data associated with the vehicle;
a processor to process the sensed data and output the processed data to the spatial light modulator as a hologram; and
a light source to output light to the spatial light modulator;
wherein the spatial light modulator diffracts the light from the hologram on the spatial light modulator and displays the hologram through a windshield of the vehicle.

16. The head-up display system of claim 15 wherein the sensed data includes data from a dashboard of the vehicle.

17. The head-up display system of claim 15 wherein the sensed data includes data regarding objects around the vehicle.

18. The head-up display system of claim 15 wherein the processor outputs additional data with the processed data to the spatial light modulator and wherein the additional data is superimposed on the sensed data displayed in the hologram.

19. The head-up display system of claim 18 wherein the additional data includes at least one of an annotation, a warning, and navigational data.
